(19) United States
(12) Patent Application Publication
(10) Pub. No.: US 2025/0271039 A1
(43) Pub. Date: Aug. 28, 2025

(54) PARKING PAWL SAFETY LATCH SYSTEM

(71) Applicant: Seakeeper, Inc., California, MD (US)

(72) Inventors: Nicholas Troche, Columbia, PA (US); Nabil Imam, Louisville, KY (US); Nicholas Tomanelli, Leesport, PA (US); James Cullum, Mohnton, PA (US)

(21) Appl. No.: 19/063,764

(22) Filed: Feb. 26, 2025

Related U.S. Application Data
(60) Provisional application No. 63/557,862, filed on Feb. 26, 2024.

(51) Int. Cl. F16D 63/00; B63B 39/04

(52) U.S. Cl. CPC F16D 63/006; B63B 39/04

(57) ABSTRACT

The present disclosure relates to a system and method to stop precession of a flywheel enclosure used in a gyroscopic roll stabilizer in aquatic vessels. The system and method includes the use of a pawl safety latch capable of interlocking connection with a gimbal shaft to prevent rotation of the gimbal shaft and prevent precession of the corresponding flywheel enclosure.

### CROSS-REFERENCE TO RELATED APPLICATIONS

This application claims the benefit and priority to U.S. provisional application Ser. No. 63/557,862 filed on Feb. 26, 2024, the foregoing hereby incorporated by reference herein.

### FIELD OF THE DISCLOSURE

The present disclosure relates to a system and method to stop precession of a flywheel used in a gyroscopic roll stabilizer in aquatic vessels in the event of braking equipment failure.

### BACKGROUND

As an aquatic vessel sits in the water, it is moved by waves, currents, and tides. These forces cause an aquatic vessel, such as a boat, to move through six degrees of freedom: three rotational movements, referred to as roll (tilting of a vessel about its longitudinal axis), pitch (up/down rotation along the transverse axis), and yaw (rotation about the vessel's vertical axis), and three translational movements, referred to as surge (linear front to back motion), sway (linear side to side motion), and heave (linear vertical motion). These motions can make life on an aquatic vessel uncomfortable or dangerous.

Historically, these motions were counteracted by stabilizing ballast, such as weighed kegs, rocks, water tank, or other heavy matter placed in the hull of the vessel to lessen the effects of these motions. These historical methods to combat unwanted vessel motion, and in particular, antiroll effects, were heavy, slowed the vessel's speed, and occupied the cargo space, making such space unusable. Modern antiroll technology has improved on these historical antiroll means. One antiroll technology is gyroscopic stabilization. Gyroscopic stabilization involves a flywheel disposed in a neutral orientation wherein the axis of rotation of the flywheel is generally parallel to either the vertical or horizontal axis of a vessel. The flywheel rotates within a flywheel enclosure producing torque and angular momentum. The flywheel enclosure is attached to a frame that is rigidly mounted to the vessel and is able to rotate about a gimbal axis that is perpendicular to the axis of flywheel rotation. As the vessel rolls, the flywheel enclosure precesses about the gimbal axis and generates torque about the roll axis of the vessel. This torque counteracts the roll of the vessel generated by a body of water, thereby stabilizing the vessel.

Control of the precession rate of the flywheel enclosure is required to realize vessel stabilization in aquatic applications. The precession rate of the flywheel enclosure is controlled through a precession braking system, which can be comprised of a combination of hydraulic, mechanical, and/or electrical components. Failure of one or more of these components could result in an uncontrolled precession rate, presenting compromised performance and safety hazards.

Therefore, there exists a long-felt, unmet need for a safer, more effective system and method to safely and securely stop gyroscopic precession in the event of an electrical or mechanical failure in aquatic vessels, and more particularly failure of any components of the precession braking system.

### SUMMARY

The present disclosure relates to a system and method to utilize a pawl to engage with a gimbal shaft from a gyroscopic stabilizer system to halt precession in the event of a power failure (or failure of braking equipment) on an aquatic vessel.

In one embodiment of the system and method, an assembly to stop precession of a flywheel enclosure in the event of a failure of braking equipment is disclosed and may include: a pawl with a pawl front latching pad, a pawl back latching pad, a pawl end stop, a pawl pivot bushing, a pawl compliance shaft, a pawl compliance sleeve, a solenoid and solenoid plunger, and a gimbal shaft end with apertures for the pawl, wherein the gimbal shaft is connected to a brake system, wherein the pawl is connected to the solenoid plunger, and wherein the solenoid plunger is electronically coupled to the solenoid such that in the event of a power failure or other braking failure, the solenoid can engage the pawl to interact with the apertures on the gimbal shaft end.

The braking equipment used to stop the precession of a flywheel enclosure in a gyroscopic roll stabilizer is commonly made of hydraulic, mechanical, magnetic, or electrical components, or a combination thereof. If the braking equipment fails to operate as intended, the effectiveness of the braking equipment may be compromised and produce a safety hazard that is only mitigated through locking the flywheel enclosure from precessing. The parking pawl safety latch is a novel concept to stop precession of the flywheel enclosure in the event of a failure of the precession braking equipment.

In this preferred embodiment of the present disclosure, the parking pawl safety latch stops uncontrolled precession of the flywheel enclosure without the use of the compromised precession braking system.

In another embodiment, the parking pawl safety latch assembly may include a gimbal shaft with two openings which act as lock points and parking pawl safety latch that may include a pawl disposed adjacent a distal end of a latch that is shaped to engage with one of the openings to immediately lock the gimbal shaft in place to prevent any further rotation of the flywheel enclosure and prevent disengagement of the pawl from the opening.

The parking pawl safety latch assembly of the present disclosure can be used to stop rotation of the flywheel enclosure (1) as a safety response to an alarm or fault condition, (2) to limit precession travel beyond the functional maximum, or (3) as the standard means to shut down the gyroscopic roll stabilizer.

Accordingly, it is an object of the disclosure not to encompass within the disclosure any previously known product, process of making the product, method of using the product, or method of treatment such that Applicants reserve the right and hereby disclose a disclaimer of any previously known product, process, or method. It is further noted that the disclosure does not intend to encompass within the scope of the disclosure any product, process, or making of the product or method of using the product which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product disclosed herein.

It is noted that in the present disclosure and particularly in the claims and/or paragraphs, terms such as “comprises,” “comprised,” “comprising” and the like can have the meaning attributed to them in U.S. patent law; for example, they can mean “includes,” “included,” “including,” and the like; and that terms such as “consisting essentially of” and “consists essentially of” have the meaning ascribed to them in U.S. patent law; for example, they allow for elements not explicitly recited, but exclude elements that are found in the prior art or that affect a basic or novel characteristic of the invention.

These and other embodiments are disclosed or are obvious from and encompassed by the following Brief Description of the Drawings and Detailed Description.

### BRIEF DESCRIPTION OF THE DRAWINGS

FIG. 1 demonstrates an embodiment of the present disclosure, wherein a pawl is mechanically linked to a solenoid plunger and can be activated when power is terminated.

FIG. 2 depicts a side view of the pawl and solenoid plunger of FIG. 1.

FIG. 3 depicts a perspective view of the pawl and solenoid plunger of FIG. 1.

FIG. 4 depicts a second perspective view of the pawl and solenoid system attached to the mounting bracket by a pawl compliance shaft.

FIG. 5 depicts a third perspective view of the pawl and solenoid system attached to the mounting bracket by a pawl compliance shaft.

FIG. 6 depicts an exploded view of the components of the pawl, solenoid system, and connecting hardware.

FIG. 7 depicts an embodiment of the pawl in a locked configuration.

FIG. 8 depicts a side view of the pawl detached from the solenoid system.

FIG. 9 depicts a second side view of the pawl detached from the solenoid system.

FIG. 10 depicts a front view of the pawl detached from the solenoid system.

FIG. 11 depicts a perspective view of a gyroscopic roll stabilizer when the flywheel enclosure is in a rested position.

FIG. 12 depicts a side view of the gyroscopic roll stabilizer of FIG. 11.

FIG. 13 depicts a side view of the gyroscopic roll stabilizer of FIG. 11 with the side rail and gimbal shaft cover removed.

FIG. 14 depicts an exploded view of the flywheel enclosure and flywheel from the gyroscopic roll stabilizer of FIG. 11.

FIG. 15 depicts a perspective view of a gyroscopic roll stabilizer when the flywheel enclosure is rotated in a forward position.

FIG. 16 depicts a side view of the gyroscopic roll stabilizer of FIG. 15.

FIG. 17 depicts a side view of the gyroscopic roll stabilizer of FIG. 15 with the side rail and gimbal shaft cover removed and the parking pawl engaged with the gimbal shaft.

FIG. 18 depicts a perspective view of a gyroscopic roll stabilizer when the flywheel enclosure is rotated in a rear position.

FIG. 19 depicts a side view of the gyroscopic roll stabilizer of FIG. 18.

FIG. 20 depicts a side view of the gyroscopic roll stabilizer of FIG. 18 with the side rail and gimbal shaft cover removed and the parking pawl engaged with the gimbal shaft.

### DETAILED DESCRIPTION

The following detailed description, given by way of example, but not intended to limit the invention solely to the specific embodiments described, may best be understood in conjunction with the accompanying drawings.

The present disclosure relates generally to an assembly, a system and a method 100 to safely stop a flywheel enclosure 202 in a gyroscopic roll stabilizer 200 from precessing in an uncontrolled manner in the event of a braking or electrical failure. In an embodiment, the flywheel enclosure 202 houses a flywheel 204 which is disposed in a neutral orientation wherein the axis of rotation of the flywheel 204 is generally parallel to either of the vertical or horizontal axis of the vessel that the gyroscopic roll stabilizer 200 is affixed to. The flywheel 204 rotates within the flywheel enclosure 202 causing the gyroscopic roll stabilizer 200 to rotate. In an embodiment, the gyroscopic roll stabilizer 200 may be affixed to a vessel by fastening the side rail 206 of the gyroscopic roll stabilizer 200 to the vessel.

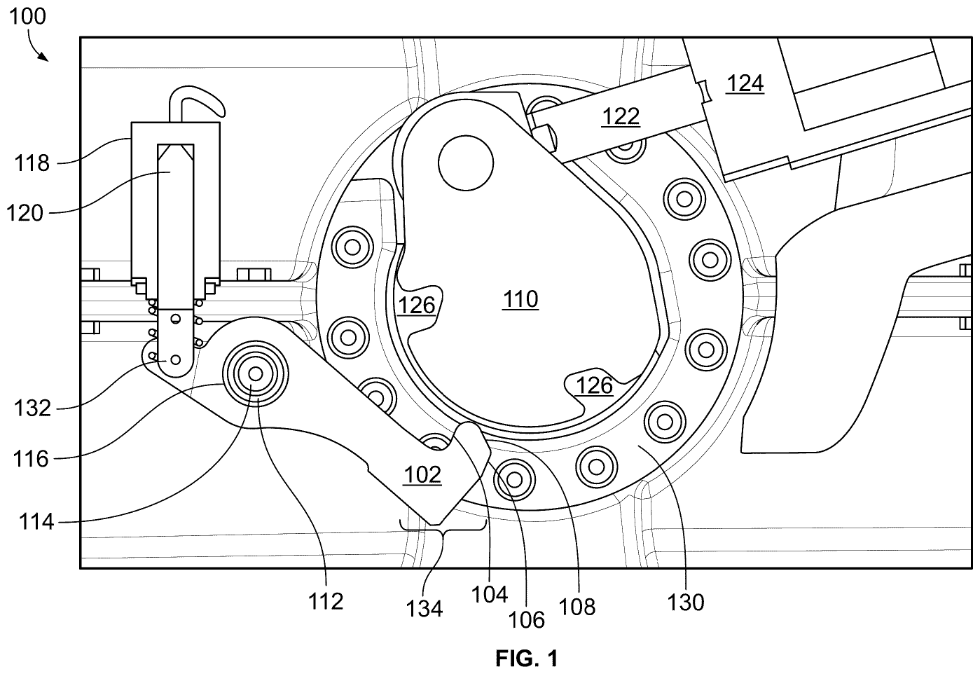

The assembly, method, and system to prevent precession of the gyroscopic roll stabilizer 200 may comprise a pawl 102, a gimbal shaft 110, apertures 126 capable of receiving the pawl 102, and an energized solenoid 118 (having a solenoid housing 136) and solenoid plunger 120 capable of exerting a force on one end of the pawl 102 during an electric, hydraulic, or mechanical failure event. The assembly or system is generally depicted by FIG. 1 (the “Parking Pawl System”). The flywheel enclosure 202 is fastened to rotating surface 130 which follows the rotation of the flywheel enclosure 202. The gimbal shaft 110 is also fastened to the rotating surface 130 and the movement of the flywheel enclosure 202 and rotating surface 130 cause the gimbal shaft 110 to rotate.

In an embodiment, a gimbal shaft cover 208 is disposed to protect the gimbal shaft 110 from external elements.

### The Pawl

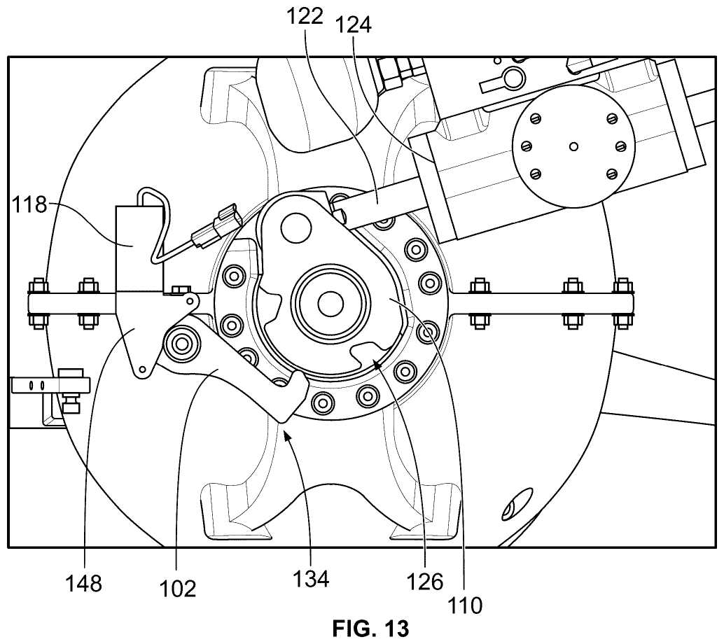

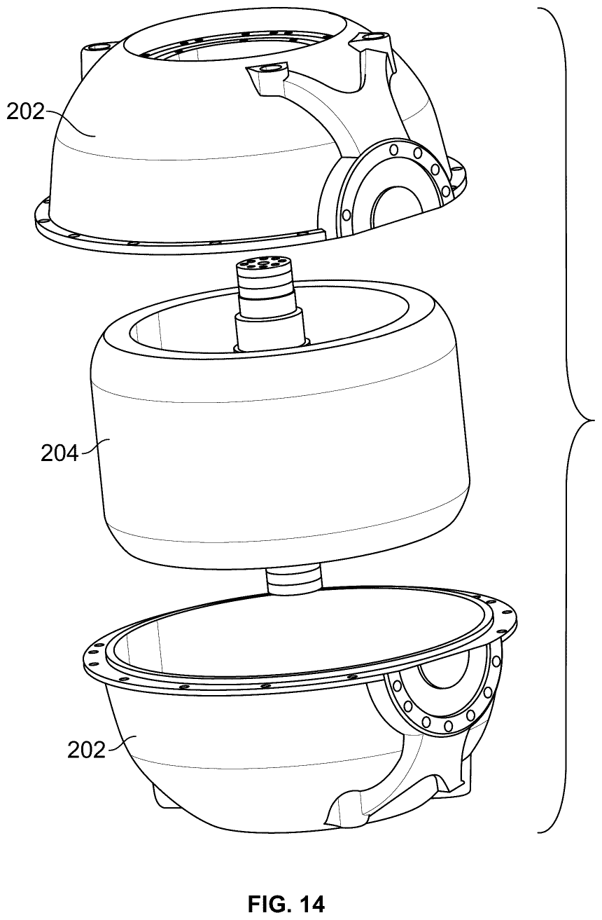

FIGS. 1 and 13 depict a pawl 102 in a disengaged configuration in relation to gimbal shaft 110. The pawl 102 comprises a first end with a latching pawl tooth 134, and a second end with a solenoid plunger connector 132. The first end of the pawl with a latching pawl tooth 134 further comprises a pawl front latching pad 104, a pawl back latching pad 106, and a pawl end stop 108. If the gyroscopic roll stabilizer 200 is operating properly, then the pawl 102 will remain disengaged from the gimbal shaft 110, and an operator can turn off the gyroscopic roll stabilizer 200 by means of a standard brake system.

The latching pawl tooth 134 of the pawl 102 may comprise a variety of shapes and configurations and is configured to correspond to the shape of the apertures 126 disposed along edges of the gimbal shaft 110 to optimize the locking action of the Parking Pawl System.

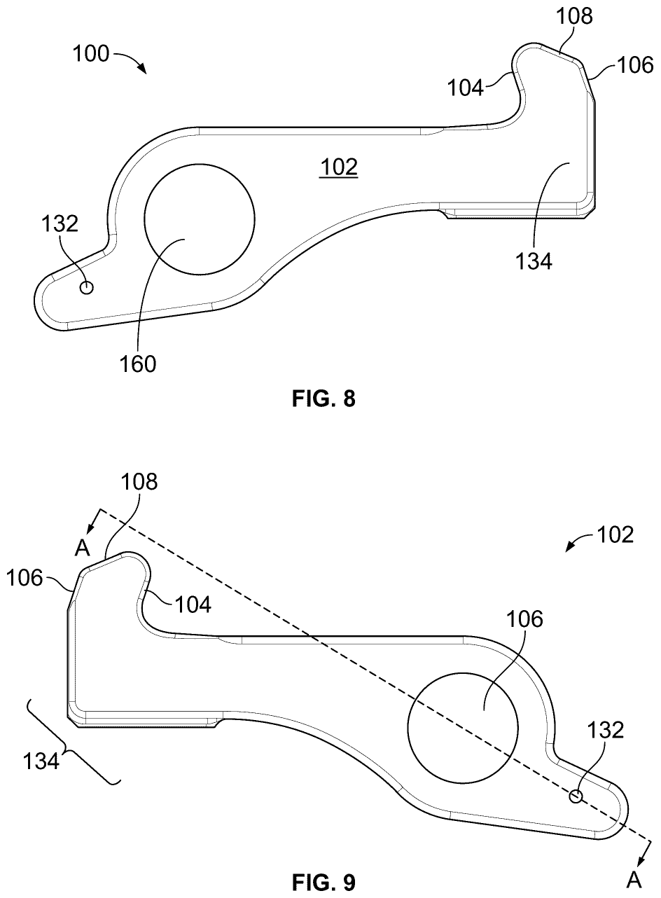

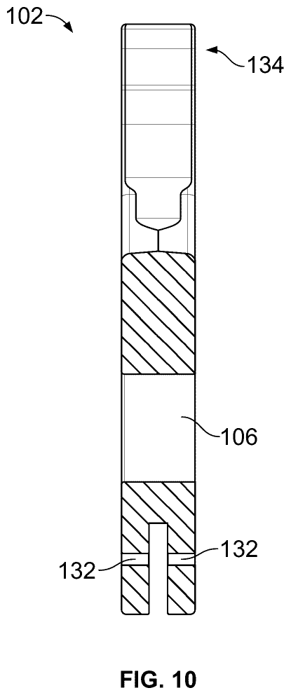

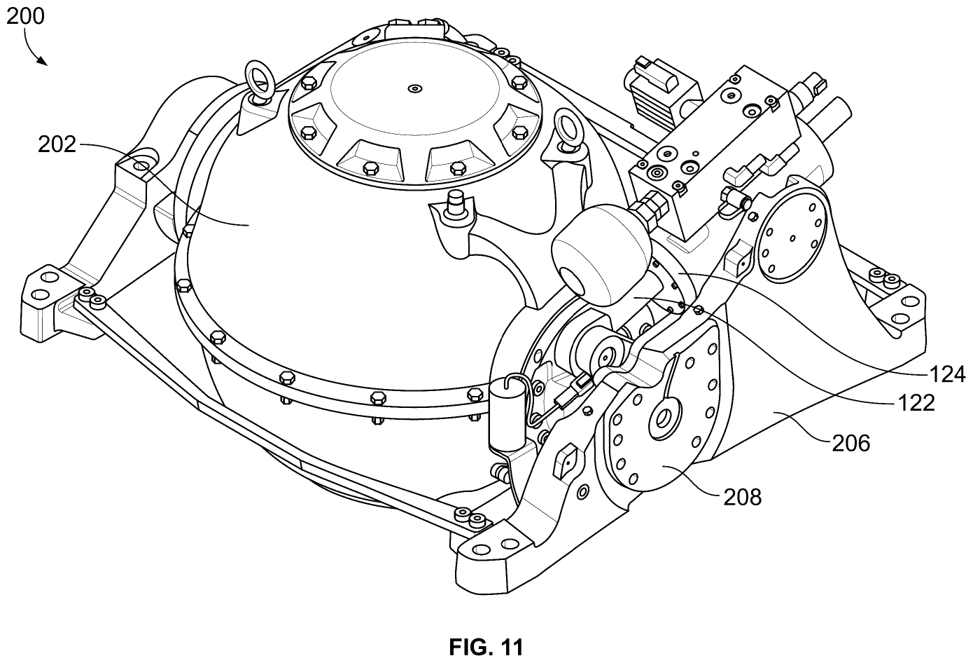

FIGS. 8-10 depict one preferred embodiment of the pawl 102, the latching pawl tooth 134, and the pawl end stop 108. In an embodiment, the linear distance between the center of the hole 160 in the pawl 102 and a first side of latching pawl tooth 134 is approximately between 3 to 5 inches. In a preferred embodiment, the linear distance between the center of the hole 160 and the first side of the latching pawl tooth 134 is approximately between 3.9 to 4.060 inches.

In an embodiment, the linear distance between the hole 160 and the second side of the latching pawl tooth 134 is approximately between 2 to 4 inches. In a preferred embodiment, the linear distance between the center of the hole 160 and the second side of the latching pawl tooth 134 is approximately between 3.090 to 3.350 inches.

In an embodiment, the angle between a plane rising vertically from the center of the hole 160 and the plane extending from the edge of the front latching pad 104 is approximately in the range of 16 to 18 degrees. In a preferred embodiment, the angle between a plane rising vertically from the center of the hole 160 and the plane extending from the edge of the front latching pad 104 is approximately 17 degrees.

In another embodiment, the angle between a plane rising vertically from the center of the hole 160 and the plane extending from the edge of the back latching pad 106 is approximately 16.8 to 18.8 degrees. In a preferred embodiment, the angle between the plane rising vertically from the center of the hole 160 and the plane extending from the edge of the back latching pad 106 is approximately 17.81 degrees.

In an embodiment, the distance between the plane formed by the pawl end stop 108 and a parallel plane extending from the center of the hole 160 is approximately between 2 to 4 inches. In the preferred embodiment, the distance between these planes is approximately 3.008 inches. The angle formed by a plane extending from the pawl end stop 108 and a plane extending horizontally from the center of the hole 160 is approximately between 21 to 23 degrees. In the preferred embodiment, the angle between these planes is approximately 22 degrees.

In an embodiment, the distance from the bottom side of the pawl 102 to the topmost portion of the latching pawl tooth 134 is approximately between 1.5 to 2.5 inches. In the preferred embodiment, the distance is approximately 1.821 inches.

In one preferred embodiment of the present disclosure, the latching pawl tooth 134 and apertures 126 are configured to lock together while the gimbal shaft 110 is mid-rotation to bring the rotation of the gimbal shaft 110 to an immediate stop. The latching pawl tooth 134 is designed and operationally tested under full load to achieve the lock action when the gimbal shaft 110 is rotating at significant angular velocity. The latching pawl tooth 134 is configured to remain engaged with the apertures 126 after an abrupt stop or brake.

In one embodiment of the present disclosure, the latching pawl tooth 134 and apertures 126 may lock together while the gimbal shaft 110 is precessing at a speed of up to 650 degrees per second. However, larger or smaller embodiments of the present disclosure may be developed to achieve the same objectives, at a different scale, to achieve the intended functionality. For instance, in smaller alternative embodiments, the latching pawl tooth 134 and apertures 126 are configured to lock together at lower precessing speeds, and in larger alternative embodiments, the latching pawl tooth 134 and apertures 126 are configured to lock together at high precessing speeds.

### Braking System

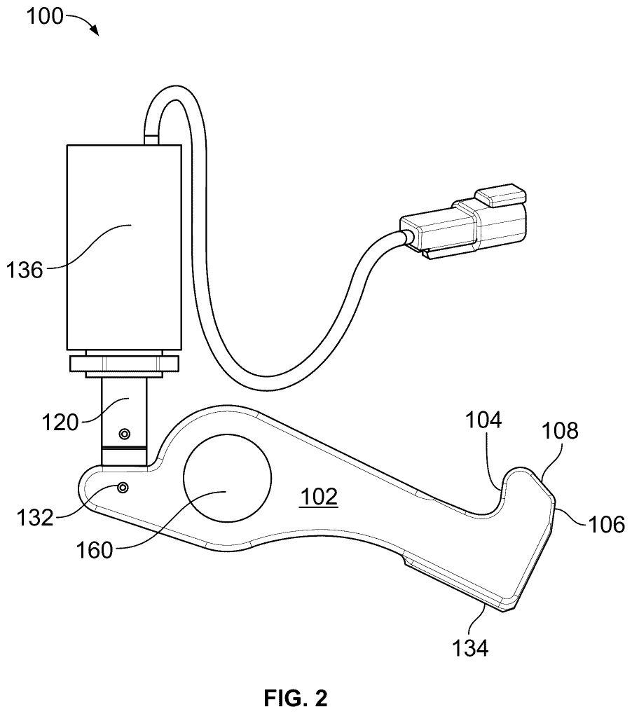

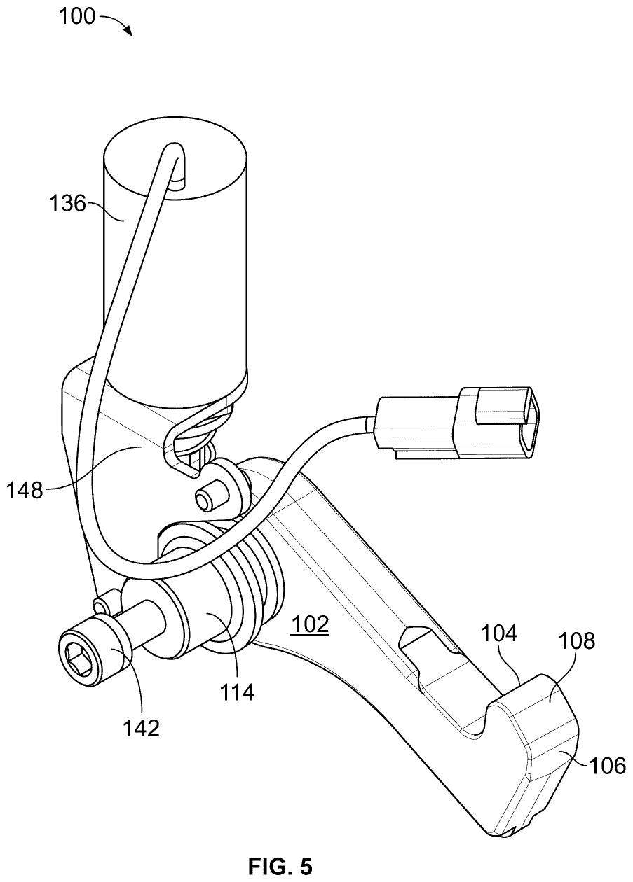

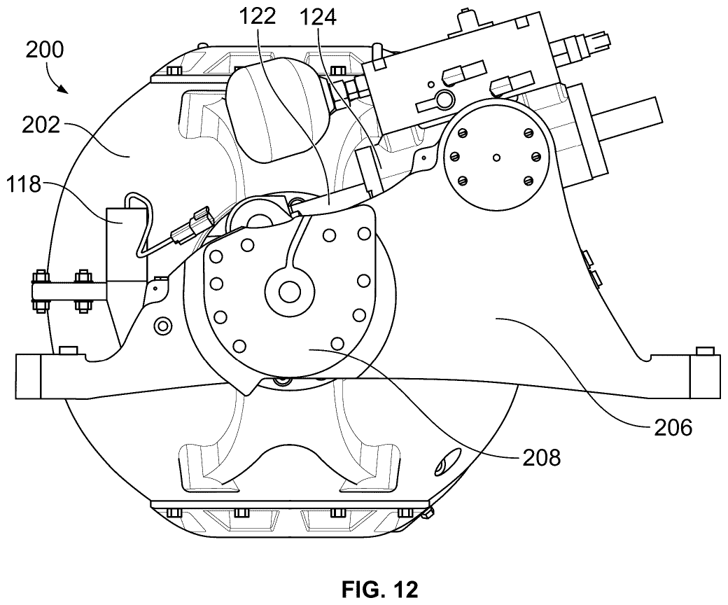

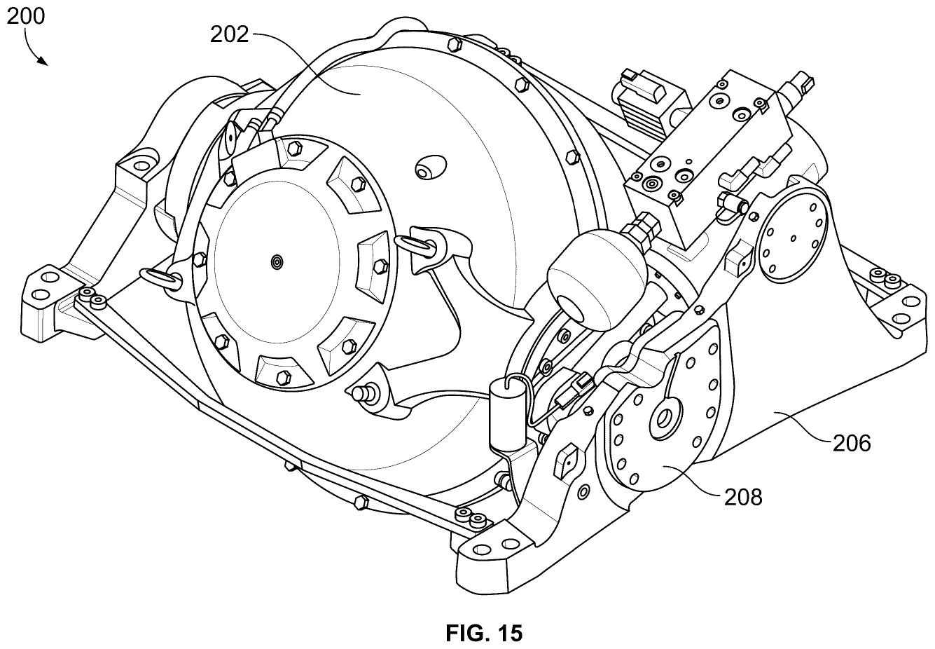

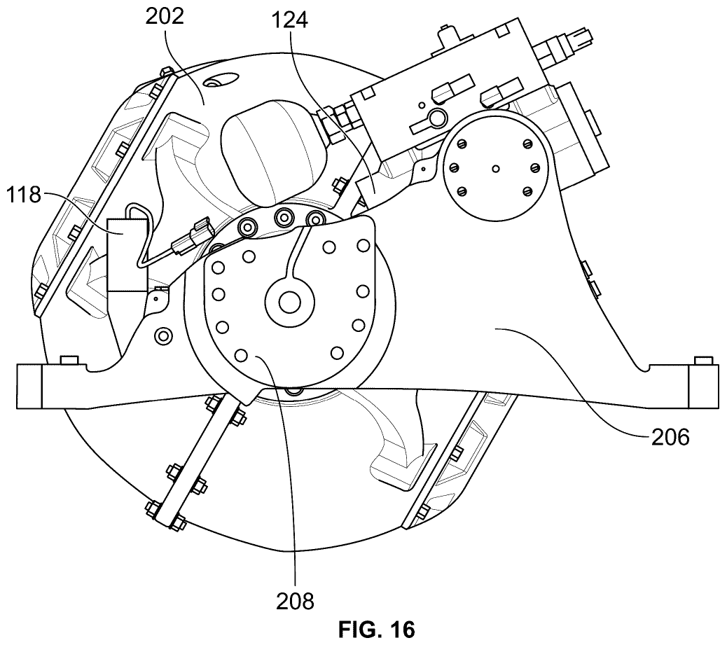

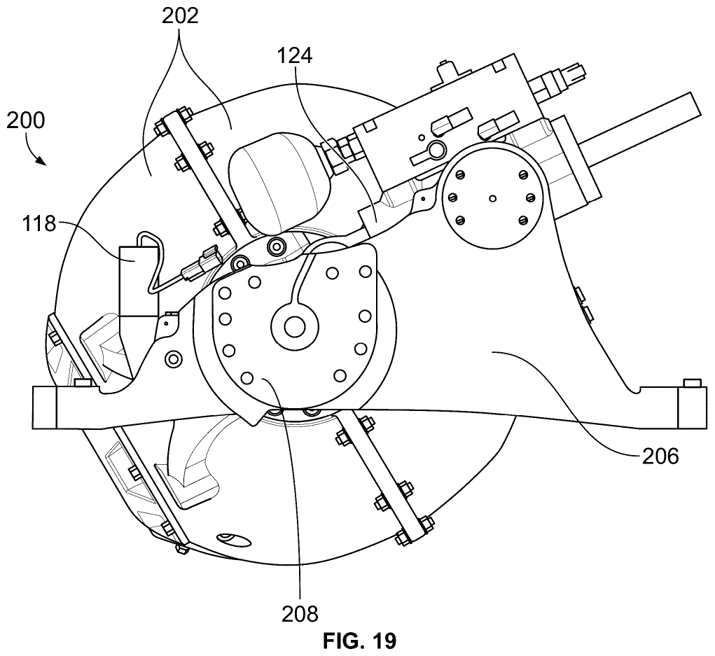

In an embodiment of the present invention, the Parking Pawl System acts as a backup to a standard brake system for the flywheel enclosure 202. The braking system may be any applicable or desirable braking system that achieves the intended purpose as would be understood by one of ordinary skill in the art. FIGS. 1 and 11-20 depict elements of a standard braking system which may include a brake actuator (or “braking actuator”) 124 and brake actuator rod (or “actuator rod”) 122. As shown, the brake actuator rod 122 is mechanically attached to the gimbal shaft 110 and capable of slowing the rotation of the flywheel enclosure 202 when activated. When the braking system is not activated, the solenoid 118 remains energized by an electricity source, such as a battery, and does not engage the solenoid plunger 120 or exert a force on the pawl 102. FIGS. 2-5 depict the solenoid plunger 120 connected to the pawl 102 by means of a connection rod 158. The solenoid plunger 120 is connected at one end to the pawl 102 and connected at the other end to a solenoid housing 136.

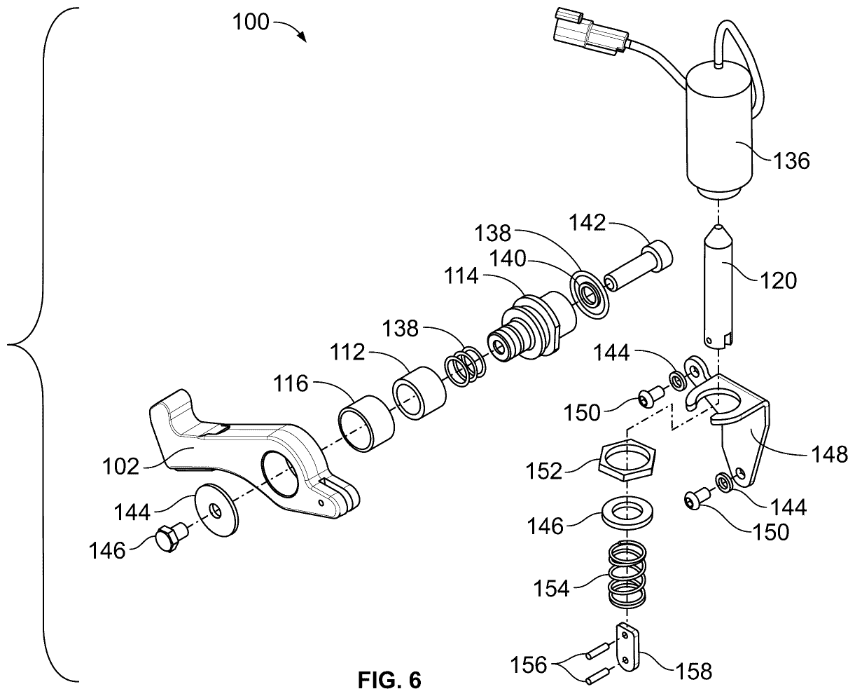

FIG. 6 depicts an exploded view of the Parking Pawl System 100. As shown in FIG. 6, the pawl 102 is operatively connected to a solenoid plunger 120 and the solenoid plunger 120 is detachably connected to the solenoid housing 136.

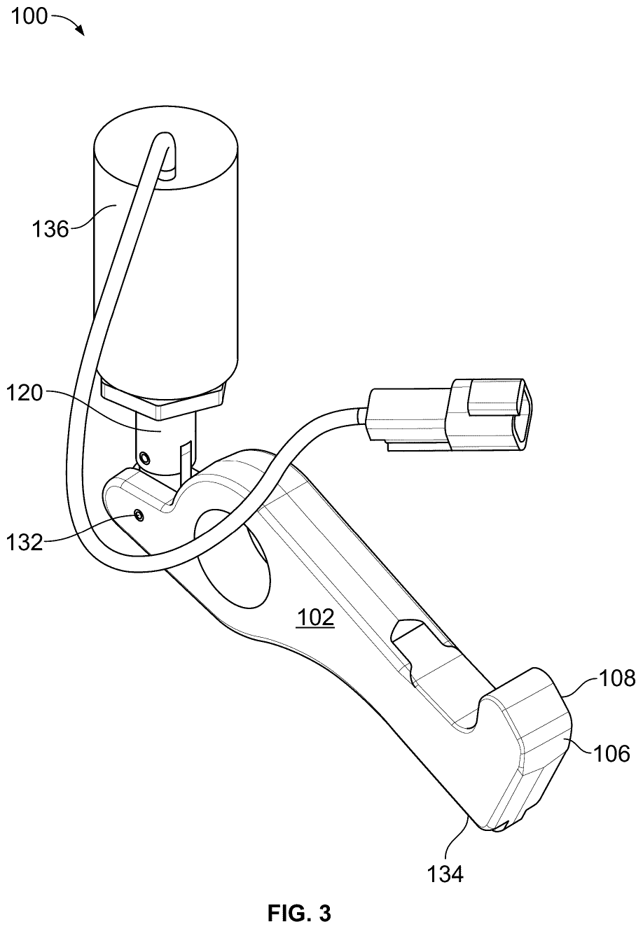

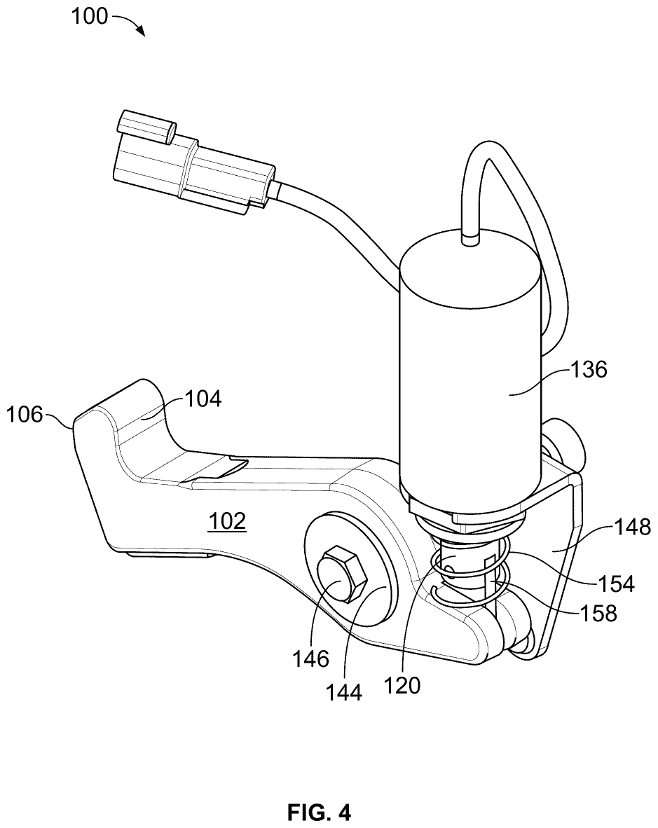

The solenoid plunger 120 is connected to pawl 102 via a connecting rod 158 and two roll pins 156. A first end of the connecting rod 158 is positioned in a groove in an end of the solenoid plunger 120 and a second end of the connecting rod 158 is positioned in a groove in an end of the pawl 102. A first roll pin 156 extends through a series of holes proximate to the groove in the solenoid plunger 120 such that a first roll pin 156 extends through the plunger and the connecting rod 158. A second roll pin 156 extends through the pawl 102 (at the solenoid plunger connector 132) and the connecting rod 158. FIGS. 3-4 depict the roll pins 156 and connecting rod 158 configured to connect the solenoid plunger 120 to the pawl 102.

A spring 154, washer 146, nut 152, and mounting bracket 148 allow the solenoid plunger 120 to exert a force on one end of the pawl 102 in the event that solenoid 118 and the solenoid plunger 120 are de-energized, such as in the event of an electrical failure. When energized, the solenoid 118 retracts the solenoid plunger 120 into a non-extended disposition, compressing the spring 154 between the solenoid 118 and pawl 102. When the solenoid plunger is de-energized, the spring 154 expands and applies a force on the pawl 102 to cause rotation of the pawl 102.

A mounting bracket 148 may be affixed to any component of an aquatic vessel as may be necessary, and may be affixed with a plurality of screws 150 and washers 144, as depicted in FIG. 6. FIG. 6 further depicts components which allow the pawl 102 to rotate when needed. A hole 160 in the pawl 102 may receive a pawl pivot bushing 116. The pawl pivot bushing 116 may receive a pawl compliance sleeve 112. The pawl compliance sleeve 112 contains a plurality of O-rings 138. The O-rings 138 surround a 1-inch compliant latch mechanism shaft 114.

In an embodiment, an additional O-ring 138 may be situated on the opposite side of the 1-inch compliant latch mechanism shaft 114. The O-ring 138 on the opposite side of the 1-inch compliant latch mechanism shaft 114 is positioned substantially around a washer wedge lock 140. A fastener socket 142 extends through the washer wedge lock 140 and into the 1-inch compliant latch mechanism shaft 114 and is capable of receiving a fastener 146.

In an embodiment, a fastener 146 may be inserted through a washer 144 on one side of the pawl 102 and through the hole 160 to connect with the fastener socket 142 on the opposite side of the pawl 102 to ensure that the components depicted in FIG. 6 remain connected and operational.

The components depicted in FIG. 6 permit the pawl 102 to rotate around the axis formed by the fastener 146 and the fastener socket 142 such that when a force is exerted on one end of the pawl 102 by the solenoid plunger 120, the other end of the pawl 102 moves to engage with the apertures 126 in the gimbal shaft 110 to stop unwanted precession of the flywheel enclosure 202.

In the event that the standard braking system successfully stops the rotation of the flywheel enclosure 202, the Parking Pawl System 100 may be activated to act as a backup system to further keep the flywheel enclosure 202 from rotating.

### Braking System Failure

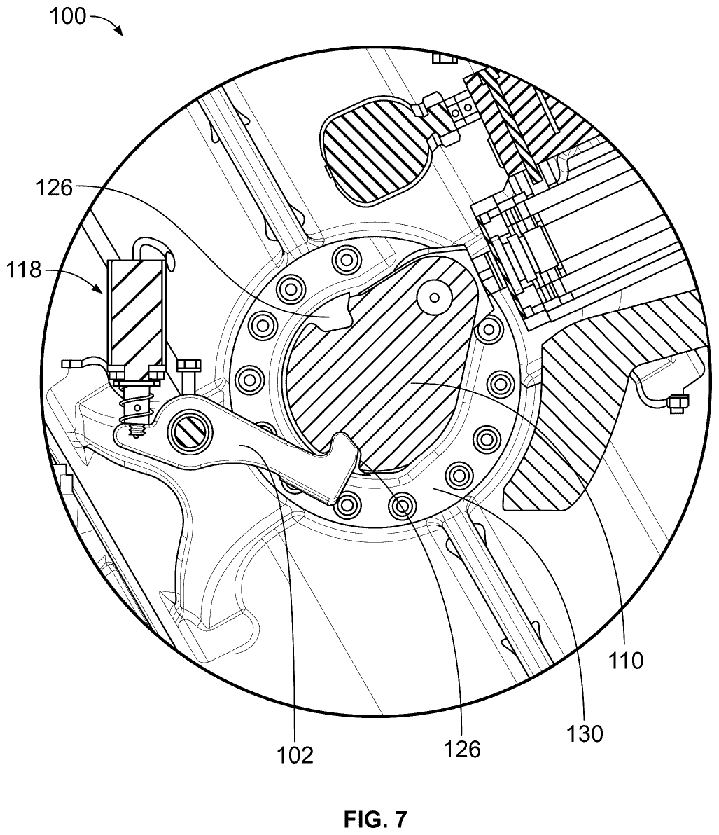

In the event of a mechanical, electrical, or hydraulic failure in the braking system or if the gyroscopic roll stabilizer 200 experiences a loss of power, the braking actuator 124 may be unable to actuate the actuator rod 122 and thus may be unable to slow the motion of the flywheel enclosure 202 and the Parking Pawl System 100 will be activated. FIGS. 7, 17, and 20 depict the pawl 102 in locked configurations wherein the latching pawl tooth 134 is engaged with an aperture 126 in the gimbal shaft 110. The Parking Pawl System 100 may also be activated if a safety alarm or a fault condition is detected in any operations system or if the flywheel enclosure 202 precession travel is beyond its functional maximum. In such events, the standard braking system may be unable to stop uncontrolled flywheel enclosure precession, which can, if unbraked, reach angular velocities of up to 600 degrees/second and cause serious damage to the aquatic vessel or bodily harm to its occupants.

For example, the braking actuator 124 and actuator rod 122 may be a hydraulic braking system. Should the hydraulic braking system lose all hydraulic pressure, or if the components themselves actually break, the hydraulic braking system will fail and lose control of the rotation of the flywheel enclosure 202.

The solenoid 118 is part of the Parking Pawl System 100 and is a redundant and wholly separate braking system from the braking actuator 124 and actuator rod 122.

In the event of a mechanical failure or electrical failure of the braking system, the solenoid 118 will engage the solenoid plunger 120. When energized, the solenoid 118 retracts the solenoid plunger 120 into a non-extended disposition. The solenoid 118 remains energized when the system is operational and holds back the solenoid plunger 120 from moving to engage with the pawl 102. If the gyroscopic stabilizer 200 loses power, or if another fault triggers an alarm, the solenoid 118 will de-energize and the spring 154 will cause the solenoid plunger 120 to extend, thereby engaging the motion of the pawl 102. When the solenoid 118 is de-energized, the solenoid plunger 120 will be engaged. When engaged, the solenoid plunger 120 exerts a force on one end of the pawl 102. The solenoid plunger 120 is mechanically coupled to one end of the pawl 102 at the solenoid plunger connector 132. When the solenoid plunger 120 exerts a force on the pawl 102, the pawl 102 rotates around a rotation point.

In an embodiment, the pawl rotation point includes a pawl pivot bushing 116, a pawl compliance shaft 114, and a pawl compliance sleeve 112. Together, the pawl pivot bushing 116, the pawl compliance shaft 114, and the pawl compliance sleeve 112 allow the pawl 102 to rotate in such a way that when one end of the pawl 102 is moved by the solenoid plunger 120, the other end of the pawl 102 (the latching pawl tooth 134) is able to move into an engaged configuration with the apertures 126 of the gimbal shaft 110, thereby locking the flywheel enclosure 202 from continuing to exert a rotation force.

Whereas one end of the pawl 102 is coupled to the solenoid plunger 120, the other end of the pawl 102 comprises a latching pawl tooth 134. The latching pawl tooth 134 can be inserted into one of multiple apertures 126 in the gimbal shaft 110. Once the latching pawl tooth 134 is engaged in an aperture 126 of the gimbal shaft 110, the stabilization system will brake regardless of whether there is power supplied to the system or not. Because the solenoid 118 activates the solenoid plunger 120 when there is a loss of power, thereby engaging the pawl 102 to brake the system, any rotation of the flywheel enclosure 202 will be controlled, even if other systems on a vessel have failed. This is preferred to other emergency braking systems, such as hydraulic braking systems, which are more complex, require electricity to operate, and may not remain engaged or locked in the event of power loss.

### Apertures and Pawl Latching End

The latching pawl tooth 134 is configured to fit into at least one corresponding aperture in the gimbal shaft 110. Two apertures 126 are positioned within the gimbal shaft 110. In the preferred embodiment, the two apertures 126 are positioned at the maximal rotational angle of the gimbal shaft 110. This allows the pawl 102 to lock the movement to the gimbal shaft 110 immediately once the pawl latching pad engages with the aperture 126. Alternative embodiments may comprise greater than or less than two apertures 126 which are positioned within the gimbal shaft 110 at any number of angles or desirable positions.

The shape of the pawl latching end shown in FIG. 1 is shown as an example, but the latching pawl tooth 134 may be any geometric shape so as to maximize locking ability within the apertures; likewise, the corresponding apertures 126 may be any shape capable of receiving the latching pawl tooth 134. The aperture 126 and the latching pawl tooth 134 are preferably shaped to maximize locking power and stability even when the gimbal shaft is rotating with significant angular velocity. Preferably, the latching pawl tooth 134 of the pawl 102 is configured such that once it is locked into a corresponding aperture 126, the latching pawl tooth 134 cannot disengage accidentally.

FIGS. 15-17 depict the gyroscopic roll stabilizer 200 rotated in a forward position with the pawl 102 activated to prevent rotation of the gyroscopic roll stabilizer 202. When the gyroscopic roll stabilizer 200 is rotated in the forward position, the latching pawl tooth 134 is disposed within an aperture 126 of the gimbal shaft 110 such that the back latching pad 106 is disposed in contact with an internal wall of the aperture 126. In an embodiment, a flat edge of the back latching pad 106 is flush with an internal wall of the aperture 126. Similarly, at least a portion of the pawl end stop 108 is disposed in contact with another internal wall of the aperture 126. In an embodiment, a flat edge of pawl end stop 108 is flush with a portion of an internal wall of the aperture 126.

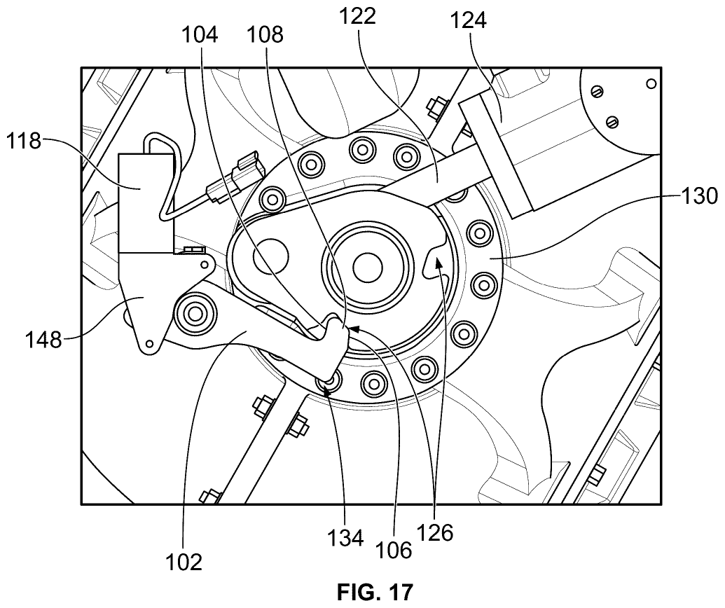

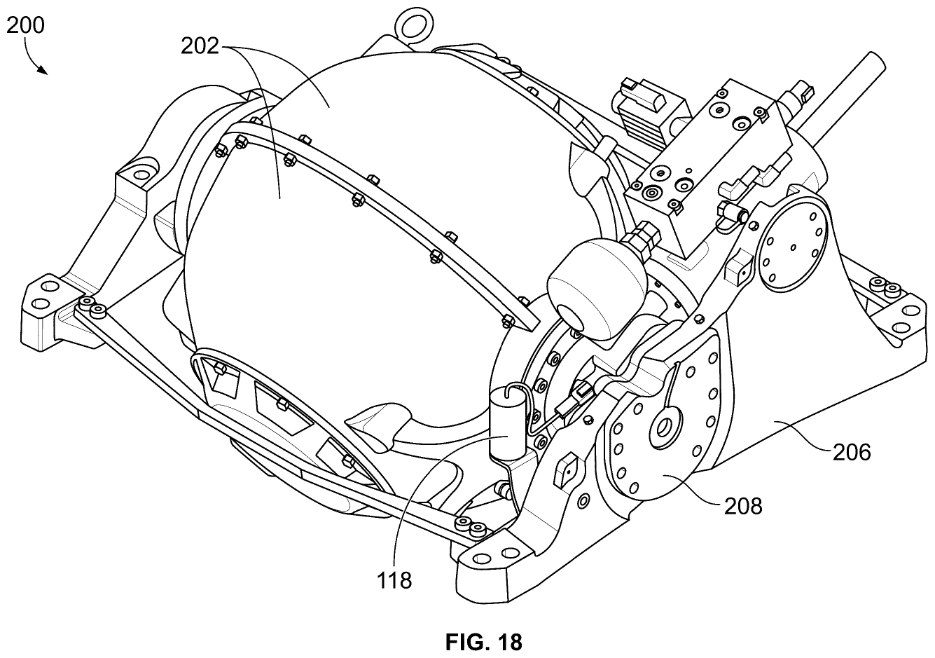

In the embodiment shown in FIG. 17, the latching pawl tooth 134 is disposed within the aperture 126 such that it prevents the gimbal shaft 110 from rotating back to a rested position (as seen in FIGS. 11-14) or a rearward position. The back latching pad 106 applies force on the wall of the aperture which prevents the gimbal shaft 110 from rotating back to its rested position (or a rearward position). If the gimbal shaft 110 continued to rotate in a forward direction, the front latching pad 104 would come into contact with an internal wall of the aperture 126 and prevent further forward rotation of the gimbal shaft 110.

FIGS. 18-20 depict the gyroscopic roll stabilizer 200 rotated in a rearward position with the pawl 102 activated to prevent rotation of the gyroscopic roll stabilizer 202. When the gyroscopic roll stabilizer 200 is rotated in the rearward position, the latching pawl tooth 134 is disposed within an aperture 126 of the gimbal shaft 110 such that the front latching pad 104 is disposed in contact with an internal wall of the aperture 126. In an embodiment, a flat edge of the front latching pad 104 is flush with an internal wall of the aperture 126. Similarly, at least a portion of the pawl end stop 108 is disposed in contact with another internal wall of the aperture 126. In an embodiment, a flat edge of pawl end stop 108 is flush with a portion of an internal wall of the aperture 126.

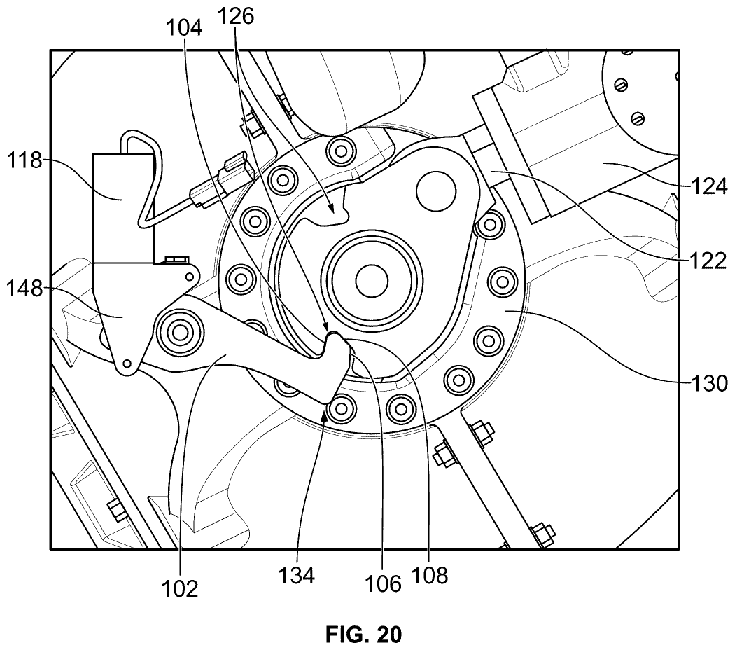

In the embodiment shown in FIG. 20, the latching pawl tooth 134 is disposed within the aperture such that it prevents the gimbal shaft 110 from rotating back to a rested position (as seen in FIGS. 11-14) or a forward position. The front latching pad 104 applies a force on the wall of the aperture 126 which prevents the gimbal shaft 110 from rotating back to its rested position (or a forward position). If the gimbal shaft 110 continued to rotate in a rearward direction, the back latching pad 106 would come into contact with an internal wall of the aperture 126 and prevent further rearward rotation of the gimbal shaft 110.

In an embodiment, and as depicted in FIGS. 11-20, the apertures 126 of the gimbal shaft 110 comprise 3 internal walls which generally correspond with the front latching pad 104, back latching pad 106, and pawl end stop 108. A first aperture 126 is used to stop the gimbal shaft in a forward position, and a second aperture 126 is used to stop the gimbal shaft in a rearward position. In alternative embodiments, the gimbal shaft 110 may comprise a single aperture 126 or more than two apertures 126.

### Catastrophic Failure Test Results

It has been observed that during a catastrophic failure, the flywheel enclosure 202 is capable of rotating at a rate of approximately 600 degrees/second. This angular velocity can take hours to slow down and stop if unrestrained by the brake system or the pawl 102. An angular velocity of this magnitude is also capable of causing serious damage to a vessel and causing injury to vessel occupants.

The pawl 102 disclosed herein has been tested under full load conditions and was successfully able to stop uncontrolled rotation of the flywheel enclosure 202. In particular, the pawl 102 was observed to engage with the aperture and lock the motion of the flywheel enclosure 202 at an angular velocity of up to 600 degrees/second (the maximal observed rate of rotation in an uncontrolled system). In an embodiment, the pawl 102 may engage with the aperture and lock the motion of the flywheel enclosure 202 at an angular velocity of greater than 600 degrees/second.

### Pawl Misalignment Test Results

Under normal conditions, the pawl 102 and the gimbal shaft 110 face are preferably coplanar and parallel to one another. This encourages secure locking of the latching pawl tooth 134 of the pawl 102 into the apertures 126 positioned on the gimbal shaft 110. However, it is possible, during a failure or otherwise, for the pawl 102 and the gimbal shaft 110 face to be or become misaligned.

Misalignment of the pawl 102 and the gimbal shaft 110 may naturally occur through use of the device. In a preferred embodiment, the Parking Pawl System 100 uses fasteners with tight tolerances to fasten components and minimize misalignment.

It was observed that the pawl 102 is capable of successfully locking with the gimbal shaft 110 even when misaligned. In particular, it was observed that the pawl 102 was capable of forming a locking engagement with the apertures 126 in the gimbal shaft 110 with a frame misalignment of 1.5 degrees between the pawl 102 and the gimbal shaft 110 and no longer co-planar nor parallel to one another.

The Parking Pawl System 100 operates most effectively when the gimbal shaft 110 and the pawl 102 are misaligned by 1.0 degree or less. However, the pawl 102 is designed to cease the rotation of the flywheel enclosure 202 even in the event that the vertical plane of the gimbal shaft 110 and the vertical plane of the pawl 102 are misaligned by up to 1.5 degrees.

### Multi-Directional Testing

In the course of operating within a gyroscopic roll stabilizer 200, angular momentum moves the gimbal shaft 110 in multiple directions. The Parking Pawl System 100 is capable of stopping the movement of the gimbal shaft 110 regardless of its current direction of movement. Specifically, the pawl 102 is designed to successfully achieve a locking configuration with the gimbal shaft 110 by engaging the latching pawl tooth 134 into a corresponding aperture 126 while the gimbal shaft 110 is rotating with significant angular velocity in either direction of movement. This ensures that the pawl 102 will be able to lock to the gimbal shaft 110 immediately, regardless of where the gimbal shaft 110 is positioned in an arc of movement when a braking failure occurs.

Although the present invention and its advantages have been described in detail, it should be understood that various changes, substitutions, and alterations can be made herein without departing from the spirit and scope of the invention as defined in the appended claims. Having thus described in detail preferred embodiments of the present invention, it is to be understood that the invention defined by the above paragraphs is not to be limited to particular details set forth in the above description, as many apparent variations thereof are possible without departing from the spirit or scope of the present invention.

What is claimed is:

1. An emergency brake to prevent precession of a gyroscopic flywheel enclosure in the event of a braking failure, the emergency brake comprising:
a solenoid plunger having an internal portion disposed within a cavity of a solenoid and an external portion extending downward from the cavity of the solenoid, the solenoid plunger oriented to move in a linear path along a first axis;
a pawl having a first end, a second end, and a through-hole disposed therebetween, the first end of the pawl rotatably connected to the solenoid plunger;
a pivot disposed within the through-hole of the pawl, the pivot oriented to rotate the pawl around a second axis;
a gimbal shaft having a perimeter wall and a plurality of apertures disposed along the perimeter wall, the gimbal shaft oriented to oscillate about a third axis in parallel with the second axis;
wherein a latching pawl tooth extends from the second end of the pawl and is configured to engage with one of the plurality of apertures disposed along the perimeter wall of the gimbal shaft; and
wherein the solenoid, pawl, and gimbal shaft are operatively connected to a gyroscopic roll stabilizer and the gyroscopic roll stabilizer oscillates the gimbal shaft about the third axis.

2. The emergency brake of claim 1, wherein the emergency brake system moves between a disengaged position and an engaged position.

3. The emergency brake of claim 2, wherein when the system is in the disengaged position, the latching pawl tooth is spaced apart from the gimbal shaft and the gimbal shaft freely oscillates about the third axis.

4. The emergency brake of claim 2, wherein the solenoid plunger moves in a downward direction away from the solenoid to rotate the pawl from a disengaged position to an engaged position,
wherein the solenoid plunger applies downward pressure to the first end of the pawl causing the second end of the pawl to rotate upward about the second axis; and
wherein the latching pawl tooth interlocks with one of the plurality of apertures of the gimbal shaft when the pawl is in the engaged position.

5. The emergency brake of claim 2, wherein the latching pawl tooth extends perpendicular from the second end of the pawl and the latching pawl tooth comprises: a front latching pad forming a first edge of the latching pawl tooth, a back latching pad forming an opposing second edge of the latching pawl tooth, and a pawl end stop forming a third edge and connecting the front and back latching pad.

6. The emergency brake of claim 2, wherein when the system is in the engaged position, the latching pawl tooth is disposed within the apertures of the gimbal shaft and the latching pawl tooth prevents the gimbal shaft from freely oscillating about the third axis;
wherein an internal edge of one of the plurality of apertures of the gimbal shaft is in interlocking exchange with the first edge of the latching pawl tooth.

7. An emergency brake system for preventing precession of a gyroscopic flywheel enclosure comprising:
a gimbal shaft rotatable about a first axis and having a plurality of apertures disposed along a perimeter edge of the gimbal shaft;
a pawl having a first end and a second end,
wherein the pawl is rotatable around a second axis disposed between the first end and second end;
wherein the pawl and gimbal shaft are disposed within the same plane;
wherein a latching pawl tooth extends from the first end of the pawl, the latching pawl tooth being configured to engage with one of the plurality of apertures disposed along the edge of the gimbal shaft; and
a solenoid plunger partially disposed within a cavity of a solenoid and connected to the second end of the pawl.

8. The emergency brake system of claim 7, further comprising a power source electronically connected to the solenoid, such that when the power source is active the solenoid plunger is retracted within the cavity of the solenoid.

9. The emergency brake system of claim 8, further comprising a spring compressed between the second end of the pawl and the cavity of the solenoid, wherein when the power source is deactivated:
the spring de-compresses and applies a force to the solenoid to extend the solenoid plunger from the cavity of the solenoid; and
the solenoid plunger pushes the second end of the pawl downward to rotate the first end of the pawl about the second axis.

10. The emergency brake system of claim 9, wherein, when the first end of the pawl is rotated about the second axis, the latching pawl tooth engages with one of the plurality of apertures disposed along the perimeter edge of the gimbal shaft.

11. A method of braking a gyroscopic roll stabilizer where the gyroscopic roll stabilizer comprises a flywheel rotating within a flywheel enclosure causing oscillation of a gimbal shaft, the method comprising the steps of:
de-energizing a solenoid to extend a solenoid plunger along a first axis away from a solenoid housing, wherein the solenoid plunger is disposed within a cavity of the solenoid housing;
applying a downward force to a first end of a pawl with the solenoid plunger, wherein the solenoid plunger is connected to the first end of the pawl;
rotating a second end of the pawl about a second axis, the second end of the pawl comprising a latching pawl tooth; and
interlocking the latching pawl tooth within an aperture disposed within an edge of a perimeter of the gimbal shaft to prevent oscillation of the gimbal shaft.

12. The method of claim 11, wherein the latching pawl tooth extends generally perpendicular from the second end of the pawl.

13. The method of claim 11, wherein prior to de-energizing the solenoid, the flywheel enclosure is oscillating at a speed of greater than 600 degrees per second.

14. The method of claim 11, wherein prior to de-energizing the solenoid, a first braking system fails to prevent uncontrollable precession of the flywheel enclosure.

15. The method of claim 11, wherein after interlocking the latching pawl tooth within the aperture of the gimbal shaft, the method comprises the additional steps of:
re-energizing the solenoid to retract the solenoid plunger along the first axis into the cavity of the solenoid housing;
applying an upward force to the first end of the pawl with the solenoid plunger as the solenoid plunger retracts into the cavity of the solenoid housing; and
rotating the second end of the pawl about the second axis to remove the latching pawl tooth from the aperture of the gimbal shaft.
